(19) United States
(12) Patent Application Publication
(10) Pub. No.: US 2002/0122495 A1
(43) Pub. Date: Sep. 5, 2002

(54) Decompression of compressed encoded video

(76) Inventors: Wilhelmus Hendrikus Alfonsus Bruls, Eindhoven (NL); Leonardo Camiciotti, Firenze (IT)

Correspondence Address: U.S. Philips Corporation, 580 White Plains Road, Tarrytown, NY, 10591, US

(21) Appl. No.: 09/989,251

(22) Filed: Nov. 20, 2001

(30) Foreign Application Priority Data
Nov. 22, 2000 (EP) 00204127.5

(51) Int. Cl. H04N 7/12

(52) U.S. Cl. 375/240.29; 375/240.25; 375/240.12; 375/240.21

(57) ABSTRACT

Decompression of a compressed encoded video signal is provided wherein the compressed encoded signal is decoded (7) to obtain a decoded signal, and wherein the decoded signal is subjected to post-processing by temporal up-conversion (10) and, prior to said temporal up-conversion (10), spatial enhancement (9). The compressed encoded signal is preferably a signal at a reduced resolution, such as a SIF signal according to an MPEG coding standard.

The present invention relates to a method and a decoder for decompression of a compressed encoded video signal.

The invention further relates to a video recording or reproduction device.

For the compression of normal standard TV signals a so-called interlaced format is used. This standard resolution also known as D1 mode contains 2 fields each of 288 lines with 720 pixels each. By compressive encoding, e.g. according to the MPEG-2 encoding mode, this video signal information may be encoded as 36 slices of 45 macro-blocks. By use of the interlaced format the viewer is presented with good motion tracking, which is important e.g. for enabling fast pans in the reproduction of soccer.

In general, for this MPEG-2 encoding/decoding mode good picture quality can be achieved at average bit-rates of 4 to 5 Mbs.

In order to enable lower bit-rates, which would be important e.g. for long play video recording, a so-called ½ D1 mode, which still operates with an interlaced format, can be used to reduce picture resolution. By horizontal filtering and sub-sampling, the number of pixels per line is reduced to 360, which by MPEG-2 encoding results in 36 slices of 22 macro-blocks. Thereby, good picture quality can be achieved at average bit-rates of 2 to 2.5 Mbs. This is accompanied, however, by two side effects, namely less detail in the picture and a smaller number of macro-blocks, each of which carries an amount of overhead bits.

If an even lower bit-rate is desired, the most obvious solution from the MPEG point of view would be an even further reduction of the number of macro-blocks, this time in the vertical direction by use of reduced resolution, e.g. the so-called SIF (Source Input Format) progressive resolution. Thereby, average bit-rates of 1 Mbs would, in principle become possible. This would be accompanied by two problems, however, one being a reduction of picture sharpness and the other increased motion shudder, in particular in connection with fast pans, e. g. in reproduction of sports events.

A solution to overcome the problem of increased shudder would be the use of TV sets, as known in the art, operating with internal conversion of TV signals from e.g. 50 Hz to 100 Hz resulting in so-called natural motion processing. By reproduction of films with 25 Hz frames in this way shudder will largely be removed.

In addition to the obvious disadvantage following from the requirement of using a special and quite expensive type of TV equipment a further disadvantage of this solution would be degradation of the motion estimation of the natural motion TV set, which can lead to extra artifacts.

It is an object of the invention to provide advantageous decompression of a compressed encoded video signal. In particular, it is an object of the invention to provide a low bit-rate mode, while still providing a reasonably good picture quality. To this end, the invention provides a method and a decoder for decompression of a compressed encoded video signal and a video recording or reproduction device as defined in the independent claims. Advantageous embodiments are defined in the dependent claims.

According to a first aspect of the invention, the invention provides decompression of a compressed encoded video signal, wherein a decoded signal obtained by decoding of the compressed encoded signal is subjected to post-processing steps comprising temporal up-conversion and, prior to said temporal up-conversion, spatial enhancement.

By providing in the decoding chain spatial enhancement to be performed before temporal, e.g. natural motion, up-conversion, the temporal up-conversion will be improved to reduce blurring for the viewer.

A major advantage is that a bit-rate reduction to about 1 Mbs is possible (e.g. in SIF format), which will allow storage of really long play recordings, 6 to 8 hours, on a storage medium for digital video signals such as an optical disk or a hard disk and reproduction of such recordings by means of a standard TV set with a good picture quality.

According to a preferred embodiment of the invention, a spatial up-conversion is conducted prior to said spatial enhancement. In this embodiment, the picture quality is further improved. Preferably, the said spatial up-conversion comprises a vertical up-conversion conducted prior to said spatial enhancement, a horizontal spatial up-conversion being conducted after said temporal up-conversion respectively. By performing the horizontal spatial up-conversion after the temporal up-conversion, the temporal up-conversion is performed on a factor 2 smaller number of pixels. This is especially advantageous for a software implementation, because a significant number of calculations is dispensed with.

The aforementioned and other aspects of the invention will be apparent from and elucidated with reference to the embodiments described hereinafter.

In the drawings:

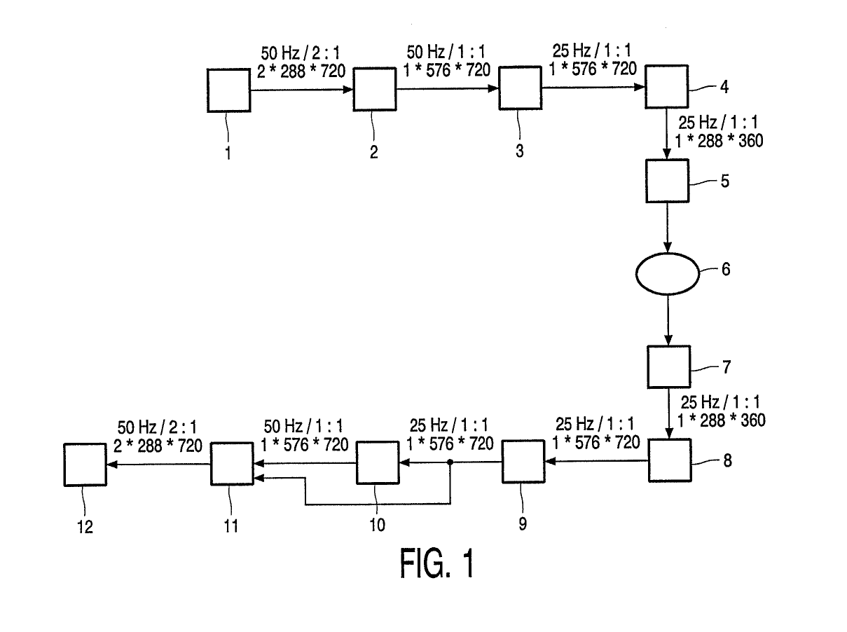

FIG. 1 is a schematic block diagram of a digital video signal compression/decompression chain according to an embodiment of the invention, and

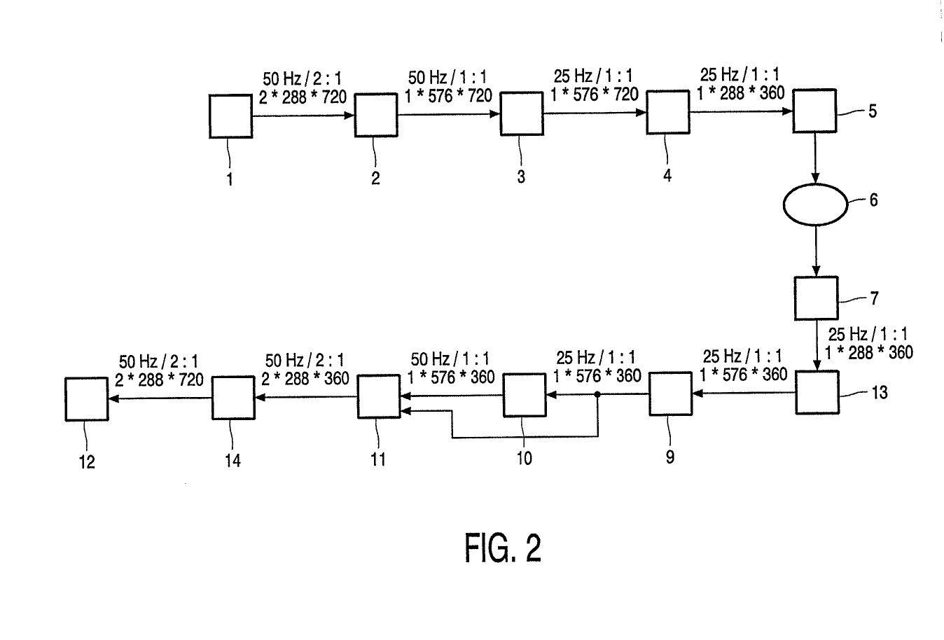

FIG. 2 is a block diagram of a further embodiment of the invention, which further embodiment is particularly advantageous for a software implementation.

In the diagram in FIG. 1, a video signal source 1 supplies a 50 Hz digital video signal in interlaced format to a de-interlacer 2, from which a non-interlaced progressive signal composed of single frames with 576 lines of 720 pixels each, which signal is called progressive D1. This progressive D1 signal is subjected to temporal down-conversion in a temporal down-converter 3 resulting in a 25 Hz signal still with single frames of 576 lines each with 720 pixels. By subsequent horizontal and vertical spatial down-conversion in a spatial down-converter 4 the number of lines is reduced by a factor 2 to 288 and the number of pixels per line is reduced by factor 2 to 360 pixels, resulting in a SIF signal. The temporal down conversion could, in principle, however, also be effected as an integral part of the de-interlacing process.

This signal is now subjected to MPEG encoding, e.g. MPEG-2, using e.g. the Berkeley software code, in an encoder 5 and is subsequently stored on a storage medium 6 such as an optical disk, CD-ROM, or a hard disk.

In the decompression chain the compressed signal obtained from the storage medium 6 is first subjected to MPEG decoding in a decoder 7, the output signal from which is a single frame signal with 288 lines each with 360 pixels. By spatial up-conversion of this signal in a spatial up-converter 8 the number of lines is doubled to 576 and the number of pixels per line to 720.

In accordance with an embodiment of the invention, the signal from the spatial up-converter 8 is now directly, i.e. before temporal up-conversion subjected to spatial enhancement in a spatial enhancement unit 9 to remove or reduce blurring in the up-converted SIF progressive signal. Preferably, this spatial enhancement is a spatial edge enhancement performed by means of a peaking filter. Peaking filtering as such is known from a publication “Video-Signalverarbeitung”, Chapter 5, Informationstechnik, B.G.Teubner, Stuttgart, 1998.

In a preferred embodiment of the invention, the peaking level is controlled by a spread of pixels in the signal. The spread is a measure based on differences between pixel values, the spread being preferably computed as a sum of absolute differences, a given absolute difference being obtained by subtracting an average pixel value from a given original pixel value. In this way, on the basis of the statistics of the pixels that are processed, it is possible to control locally the strength of the spatial enhancement in order to prevent annoying artifacts where the image content is critical, e.g. on the edges. The spatial spread Sₛₚₐₜ of five pixel values Pₜ, M₁, M₂, M₃ and M₄ may be computed as follows:

$$\begin{matrix}{M}_{ave} = \frac{( {P}_{t} + {M}_{1} + {M}_{2} + {M}_{3} + {M}_{4} )}{5} \\ & ( 1 ) \\ {S}_{spat} = \frac{abs ( {M}_{ave} - {P}_{t} ) + {\sum }_{i = 1}^{4} abs ( {M}_{ave} - {M}_{i} )}{4} & ( 2 )\end{matrix}$$

For further information on spread, reference is made to non pre-published European patent application 00202076.6, filed 15.06.00 (our reference PHNL000345).

The signal from the spatial enhancement unit 9 is now supplied to temporal, e.g. natural motion, up-conversion in a temporal up-converter 10, in which the 25 Hz progressive signal is converted by interpolation into a 50 Hz signal with 576 lines each with 720 pixels.

Preferably, the input signal to the temporal up-converter 10 is further supplied directly to an input (e.g. for an odd field) of an interlacer 11; another input (e.g. for an even field) of which receives the interpolated output signal from the temporal up-converter 10. Thereby, advantage is taken of the fact that the input signal to the temporal up-converter 10 is of a higher quality than the non-interpolated output frame from the converter. This special concept of interlacing the information in the input signal for temporal up-conversion with the interpolated output from the temporal up-conversion provides a further contribution to good picture quality. In this embodiment, the output of the interlacer 11 a 50 Hz interlaced signal with two fields each with 288 lines and 720 pixels per line is now available for reproduction by means of a reproduction device 12, such as a standard TV set, for which this embodiment of the invention is especially advantageous.

In practical embodiments, the interlacer 11 may obtain the information for both fields from the output(s) of the temporal up-converter 10. In such a case, the temporal up-converter 10 may be arranged to have only a minor influence on the quality of the non-interpolated field.

In general, interlacing is especially advantageous when applied in combination with a reproduction device, such as a standard TV, reproducing a e.g. 50 or 60 Hz interlaced video signal.

In the further embodiment shown in the diagram in FIG. 2, the compression chain comprising the signal source 1, the de-interlacer 2, the temporal down-converter 3, the spatial down-converter 4 and the MPEG encoder 5, is similar to the compression chain in the diagram in FIG. 1.

Also the majority of blocks in the decompression chain such as the MPEG decoder 7, the spatial enhancement unit 9, the temporal up-converter 10, the interlacer 11 and the reproduction device 12 are similar to the blocks in the decompression chain in the diagram in FIG. 1.

The spatial up-conversion is carried out, however, in two steps, for the vertical and horizontal directions, respectively. Thus, in the illustrated example a vertical spatial up-converter 13 interconnected between the decoder 7 and the spatial enhancement unit 9 supplies a progressive output signal, in which only the number of lines is doubled to 576, whereas the number of pixels per line remains 360, whereas horizontal up-conversion is performed by a horizontal spatial up-converter 14 interconnected between the interlacer 11 and the reproduction device 12.

Thus, by this modification the temporal up-conversion in converter 10 is performed on a factor 2 smaller number of pixels, which is advantageous for a software implementation, because a significant number of calculations is dispensed with.

Whereas, the diagrams in FIGS. 1 and 2 both show embodiments of the system according to the invention intended for a video recording/reproduction application such as DVD, the configurations shown in the diagrams would be equally applicable to a broadcast application, whereby the storage medium 6 shown in both diagrams would be replaced by suitable transmission equipment, a transmission channel and receiving equipment.

In above-mentioned and other applications, the embodiment of the invention as illustrated in the diagram in FIG. 1 offers the advantage that the signal available in the decompression chain at the output of the spatial up-converter 8 would be compatible with reproduction equipment such as DVD players or TV sets, in which the specific interlacing concept offered by the invention is not applied, although such an application would not benefit from the full potential of the invention with respect to picture quality improvement in connection with low bit-rate compression and decompression.

The description above is mainly written in accordance with the PAL TV system and the MPEG encoding standards. It will be clear to a person skilled in the art that the invention can be straightforwardly applied in accordance with other systems and/or standards.

The encoding and/or decoding chains as shown in FIGS. 1 and 2 may partly or wholly be present in a video recording or reproduction device.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, decompression of a digital video signal is provided wherein a compressed encoded signal is decoded to obtain a decoded signal, and wherein the decoded signal is subjected to post-processing by temporal up-conversion and, prior to said temporal up-conversion, spatial enhancement. The compressed encoded signal is preferably a signal at a reduced resolution, such as a SIF signal according to an MPEG coding standard.

1. A method of decompression a compressed encoded video signal, the method comprising:
decoding (7) the compressed encoded video signal to obtain a decoded video signal; and
post-processing the decoded video signal by temporal up-conversion (10) and, prior to said temporal up-conversion (10), spatial enhancement (9).

2. A method as claimed in claim 1, wherein a spatial up-conversion (8) is conducted prior to said spatial enhancement (9).

3. A method as claimed in claim 2, wherein said spatial up-conversion (8) comprises a vertical up-conversion (13) conducted prior to said spatial enhancement (9), a horizontal spatial up-conversion (14) being conducted after said temporal up-conversion (10) respectively.

4. A method as claimed in claim 1, wherein said spatial enhancement (9) comprises spatial edge enhancement.

5. A method as claimed in claim 4, wherein said spatial edge enhancement (9) is carried out by peaking filtering.

6. A method as claimed in claim 5, wherein said peaking filtering is controlled by a spread of pixel values.

7. A decoder for decompression a compressed encoded video signal, the decoder comprising:
decoding means (7) for decoding the compressed encoded video signal to obtain a decoded signal; and
means for post-processing the decoded signal, the means for post-processing comprising temporal up-conversion means (10) and spatial enhancement means (9) coupled in between said decoding means (7) and said temporal up-conversion means (10).

8. A decoder as claimed in claim 7, the decoder further comprising means for spatial up-conversion (8) prior to said spatial enhancement means (9).

9. A decoder as claimed in claim 8, wherein said spatial up-conversion means (8) comprises vertical up-conversion means (13) prior to said spatial enhancement means (9), the decoder further comprising horizontal spatial up-conversion means (14) after said temporal up-conversion means (10) respectively.

10. A video recording or reproduction device comprising a decoder according to claim 7.
